(19) United States
(12) Patent Application Publication
(10) Pub. No.: US 2025/0318609 A1
(43) Pub. Date: Oct. 16, 2025

(54) ASSEMBLY OF A WRIST BAND ON A WATCH CASING

(71) Applicant: ROLEX SA, Geneva (CH)

(72) Inventors: Mathieu Cusin, Andilly (FR); Jean-Sébastien Macé, Esserts-Salève (FR)

(73) Assignee: ROLEX SA, Geneva (CH)

(21) Appl. No.: 19/169,080

(22) Filed: Apr. 3, 2025

(30) Foreign Application Priority Data
Apr. 11, 2024 (EP) 24169611.1

(51) Int. Cl. A44C 5/14

(52) U.S. Cl. CPC A44C 5/147

(57) ABSTRACT

The timepiece has at least one wristband portion (30) extending in a longitudinal direction and removably fixed to a middle (20), in a first, fixing configuration to the middle (20) and a second, assembly configuration detached from the middle (20).

In the first, fixing configuration at least one pivoting axis (2) is housed in respective transverse openings (21a, 1a, 31a) of at least one lug (21), at least one fixing element (1), and at least two connecting portions (31) of the wristband portion, and an immobilizing means (3) immobilizes at least one pivoting axis (2) against rotation relative to the at least one lug (21) and the at least one fixing element (1) or relative to the connecting portions (31) so that only the respective at least two connecting portions (31) or the at least one lug (21) and the at least one fixing clement (1) are mobile in rotation.

### CROSS-REFERENCE TO RELATED APPLICATION

This application claims priority of European patent application No. EP24169611.1 filed Apr. 11, 2024, the content of which is hereby incorporated by reference herein in its entirety.

### FIELD OF THE INVENTION

The invention concerns a timepiece comprising an advantageous assembly of a wristband on a watch case, notably on a watch middle.

### BACKGROUND ART

Various devices are used to fix a wristband in a removable and articulated manner to a middle of a wristwatch. For example, in one common prior art solution a watch middle has two pairs of lugs, each pair of lugs delimiting a housing to receive a link assembly at the end of a wristband. A pivoting axis extending between the two lugs of a pair of lugs comes into interengagement with this link assembly of the wristband, holding it in position between these two lugs, while enabling relative articulation of the wristband and the watch casing by pivoting about said pivoting axis.

Such fixing of a wristband to a watch casing, in particular to a middle, must ideally achieve the following objectives:
it must be reliable, more particularly to prevent untimely detachment of the wristband;
it must be robust, and notably prevent wear that would cause its functionality to deteriorate over time;
it must allow user-friendly removal and fixing of a wristband, for example enabling it to be replaced easily and rapidly;
it must have an attractive esthetic appearance, in particular being compatible with the esthetic requirements of top of the range timepieces.

### SUMMARY OF THE INVENTION

Existing solutions achieve at least some of the foregoing objectives but remain open to improvement. The present invention therefore has for objective improving these existing solutions.

Accordingly, a general object of the invention is an improved solution for fixing a wristband to a watch middle, more generally to a watch casing.

To be more precise, a first object of the invention is a reliable and robust solution for fixing a wristband to a watch casing.

A second object of the invention is a user-friendly solution for fixing a wristband to a watch casing.

A third object of the invention is preferably an esthetic solution for fixing a wristband to a watch casing.

To this end, the invention consists in a timepiece, notably a wristwatch, comprising at least one wristband portion extending in a longitudinal direction and removably fixed to a middle, therefore occupying a first, fixing configuration in which the at least one wristband portion is fixed to the middle and a second, assembly configuration in which the at least one wristband portion is detached from the middle, wherein:
the middle comprises at least one lug comprising a transverse opening,
the timepiece comprises at least one fixing element distinct from the middle and the at least one wristband portion comprising a transverse opening,
the end of the at least one wristband portion comprises at least two connecting portions, notably at least two connecting links, projecting in the longitudinal direction at the end of the at least one wristband portion and being transversely separated from one another by a gap, the at least two connecting portions each comprising transverse through-openings,
in a first, fixing configuration at least one pivoting axis is housed in said transverse opening of the at least one lug, in said transverse opening of the at least one fixing element, and in said transverse openings of the respective at least two connecting portions of the wristband portion, so as to retain fixed between them the middle, the at least one wristband portion and the at least one fixing element,
in a first, fixing configuration an immobilizing means immobilizes the at least one pivoting axis against rotation relative to the at least one lug and relative to the at least one fixing element or relative to the connecting portions so that only the respective at least two connecting portions of the at least one wristband portion or the at least one lug and the at least one fixing element are mobile in rotation about the at least one pivoting axis.

The invention is more precisely defined by the claims.

### BRIEF DESCRIPTION OF THE DRAWINGS

The objects, features and advantages of the present invention are described in detail in the following description of particular embodiments given by way of non-limiting example with reference to the appended figures, in which:

FIG. 1 represents a perspective view from below of the assembly in a configuration fixing a wristband to a watch casing in accordance with a first embodiment of the invention.

FIG. 2 represents an exploded perspective view of the assembly of a wristband on a watch casing in accordance with the first embodiment of the invention.

FIG. 3 represents a partially cutaway perspective view of the assembly of a wristband on a watch casing in accordance with the first embodiment of the invention.

FIG. 4 represents in lateral section an assembly of a wristband on a watch casing in accordance with a second embodiment of the invention.

FIG. 5 represents a view from above of an assembly of a wristband on a watch casing in accordance with a third embodiment of the invention.

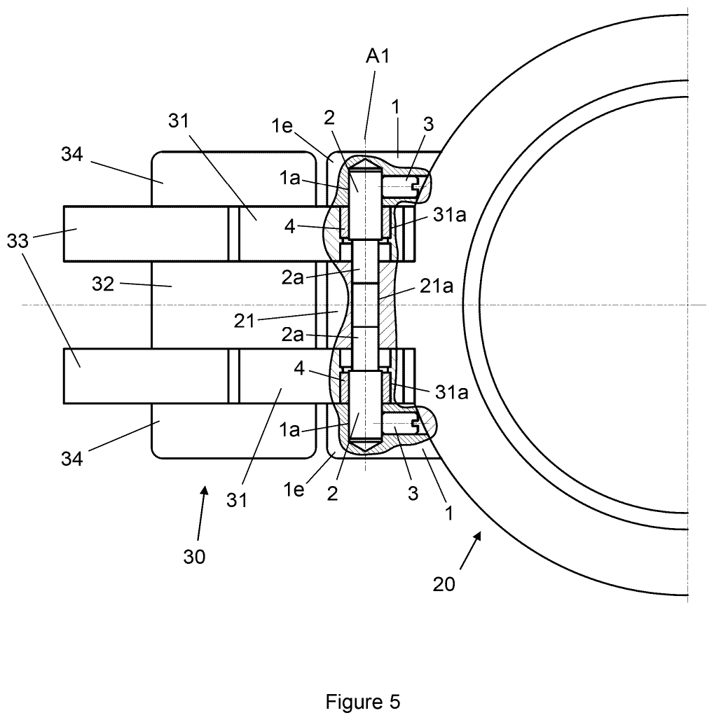

### DETAILED DESCRIPTION OF PARTICULAR EMBODIMENTS

To simplify the description of the invention identical or corresponding elements of different variants bear the same references.

By convention “longitudinal direction” means the direction in which the wristband extends from the watch casing, considering the timepiece and its wristband placed on a plane called by convention a “horizontal plane”. The transverse direction designates the direction perpendicular to the longitudinal direction in the horizontal plane. The vertical direction is perpendicular to the horizontal plane defined by the longitudinal and transverse directions.

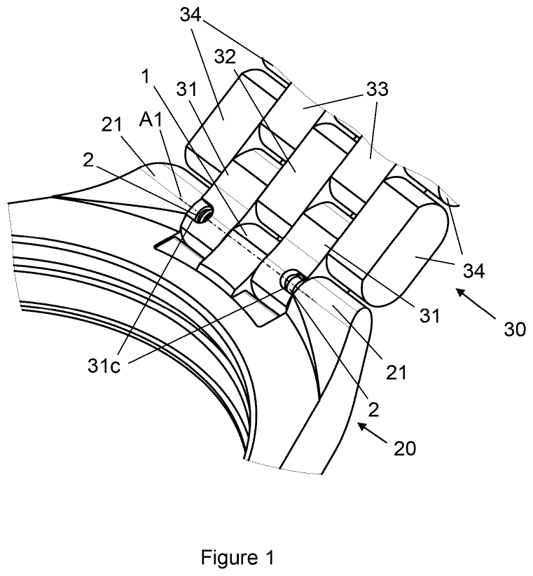

FIGS. 1 to 3 depict a first embodiment of the invention in which a particular arrangement enables the assembly of a wristband 30 on a middle 20 of a timepiece by means of a fixing element 1.

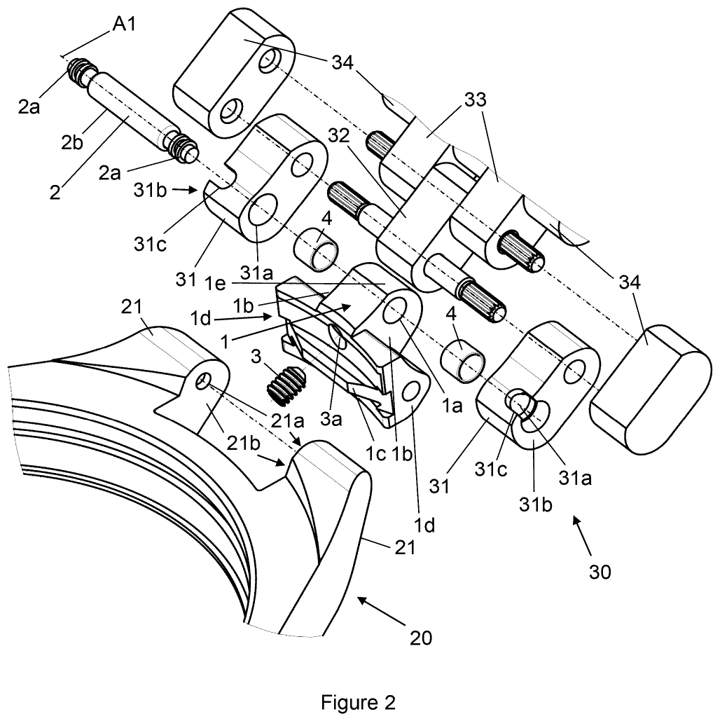

In accordance with this first embodiment the wristband 30 extends in a longitudinal direction and comprises link assemblies articulated to one another, each composed of different links. In this embodiment, a link assembly comprises five links, distributed in the transverse direction, perpendicularly to the longitudinal direction. To be more precise, each link assembly comprises two edge links 34, two intermediate links 33 and a center link 32. These five links are articulated to one another by means of a pivoting axis. Furthermore, the two intermediate links 33 are offset by one half-link in the longitudinal direction of the wristband relative to the two edge links 34 and the center link 32. This offset enables assembly of such a link assembly with another similar link assembly, the two intermediate links of that other link assembly being adapted to be articulated to the two edge links 34 and the center link 32, coming into line with the two intermediate links 33. When the wristband 30 is assembled, it has a continuous appearance in which the distinction between the various link assemblies is not very perceptible. The wristband finally comprises five rows of links. Each row comprises links aligned in the longitudinal direction. On the other hand, these rows are juxtaposed in the transverse direction, two directly adjacent rows being offset to one another in the longitudinal direction by a half-link. The end link assembly of the wristband 30, visible in FIGS. 1 and 2, is intended to be fixed to the middle 20 of a timepiece. The intermediate links 33 of this end link assembly project relative to the whole of the wristband 30 and form two connecting links of the wristband. More generally, the wristband 30 could have a geometry other than that of these two connecting links at its ends provided that it comprises at least two connecting portions 31 at those ends. In this first embodiment the wristband 30 therefore comprises two connecting portions 31 that are formed by said two connecting links.

On the other hand, in this first embodiment the middle 20 of the watch casing comprises two traditional lugs 21 adapted to receive the assembled wristband 30. The distance between the two lugs 21, referred to as the interlug distance, is preferably less than or equal to 20 mm or less than or equal to 15 mm or even less than or equal to 10 mm, for example of the order of 10 mm or of the order of 9 mm. Finally, a fixing element 1 separate from the middle 20 and the wristband 30 is positioned in an intermediate manner between the middle 20 and the wristband 30 and participates in assembling the wristband 30 on the middle 20.

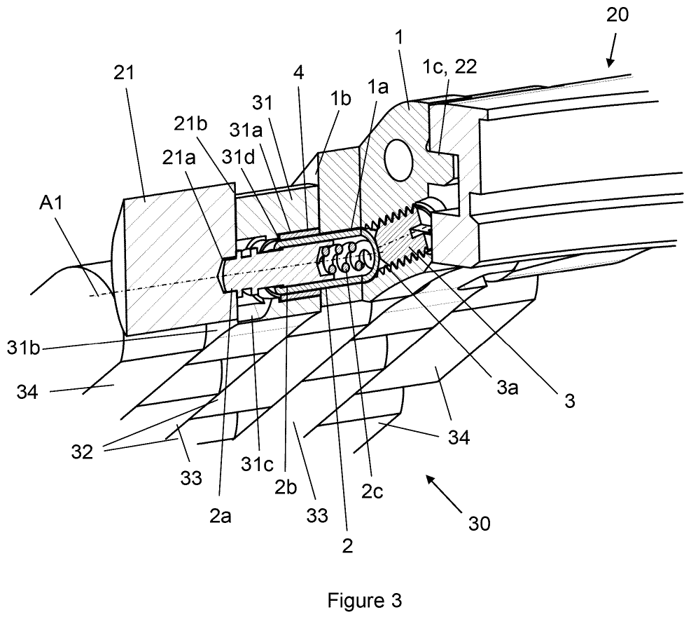

In this first embodiment the fixing element 1, seen particularly in FIG. 2, comprises a base intended to be housed between the two lugs 21 of the middle. The fixing element 1 is configured for positioning with little or no degree of freedom relative to the middle. To this end, its base has a volume defined to fit between the two lugs 21 of the middle 20. To this end, this base comprises lateral flanks 1d configured to come into contact with the internal flanks 21b of the lugs 21 so that the fixing element 1 has no freedom of movement in the transverse direction extending from one lug 21 to the other. On the other hand, the base of the fixing element 1 comprises a surface intended to come to bear against the surface of the middle between the two lugs, thereby espousing the curvature of this surface of the middle. Furthermore, this surface of the base comprises a projecting connecting portion 1c in the form of a rib intended to cooperate with a complementary hollow portion 22 of the middle 20, visible in FIG. 3, in particular a groove machined between the two lugs 21 of the middle 20. Alternatively, the hollow portion could be arranged on the base of the fixing element 1 and the complementary projection on the surface of the middle 20. This cooperation between this connecting portion 1c projecting from the fixing element 1 and the hollow portion of the middle prevents or limits movement of the fixing element 1 in a vertical direction and prevents it from rotating. The fixing element is not limited to the features described hereinabove. It could instead comprise only one of or a subset of those features.

The fixing element 1 further comprises a projecting part 1e extending from the base in a longitudinal direction away from the middle 4. This projecting part 1e is substantially parallel to the lugs 21 in the fixing configuration of the assembly. This projecting part 1e is in the central part of the fixing element, which is symmetrically arranged on either side of this projecting part 1e. On the other hand, this projecting part 1e advantageously has a shape similar to links of the wristband 30 to produce a visual effect of continuity with the wristband 30.

The wristband 30 is assembled to the middle 20 by means of a pivoting axis 2 and the fixing element 1 described hereinabove. This pivoting axis 2 in fact cooperates with these three distinct components 1, 20, 30. To this end, the pivoting axis comprises ends housed in respective transverse openings 21a, preferably blind openings, in the flanks 21b of the two lugs 21. This pivoting axis 2 then passes through transverse through-openings 31a in each connecting portion 31 of the wristband 30, that is to say the intermediate links at the end of the wristband in this embodiment. The pivoting axis 2 then passes through a transverse opening 1a in the projecting central part 1e of the fixing element. Note that because of this arrangement the pivoting axis 2, which extends transversely from one lug 21 to the other, enables finalisation of the fixing of the fixing element 1 onto the middle 20 while retaining the wristband 30 in an articulated manner on this assembly formed of the fixing element 1 and the middle 20.

In this first embodiment, the pivoting axis 2 is a conventional barette that comprises a body 2b and at least one end portion forming a pivot 2a at one end, preferably two pivots 2a, one at each respective end. Each pivot 2a slides in the body 2b. An elastic element 2c, such as a coil spring, visible in FIG. 3, is housed inside the body 2b so as to exert a force on the pivot or pivots 2a, tending to maintain it or them in a position projecting beyond the body 2b. The total length of the pivoting axis 2 is consequently slightly greater than the interlug distance, with the result that the pivots 2a can be housed in the bores 21a in their projecting position.

The length of the body 2b extends beyond the flanks 1b of the projecting part 1e of the fixing element 1 in such a manner as to cooperate with the transverse openings 31a of the connecting portions 31. The pivoting axis 2 is therefore free to slide in the transverse opening 1a of the projecting part of the fixing element 1, at least during a phase of assembling this assembly. Each pivot 2a of the pivoting axis 2 is designed so it can be positioned alternately projecting from or retracted from the external flank 31b of the connecting portions 31 so as respectively to allow a first configuration for fixing the wristband 30 to the middle 20 and a second, assembly configuration in which the wristband 30 can be locked onto or unlocked from the middle 20. Each connecting portion 31 therefore has the pivoting axis 2 pass through it and consequently is assembled between a flank 1b of the fixing element and an internal flank 21b of a lug 21. In the first, fixing configuration in which the wristband 30 is fixed to the middle 20 each pivot 2a takes its place in the blind transverse opening 21a in the internal flank 21b of each of the lugs 21. This configuration is stable because of the elastic retaining effect of the elastic element 2c. Note that in the first, fixing configuration all the aforementioned openings 21a, 1a, 31a are coaxially aligned in the same direction along an axis A1. The pivoting axis 2 is then arranged in this transverse direction of the axis A1, extending from one lug 21 to the other. The pivoting axis 2 can be made of a metal alloy such as steel or a superalloy, a composite material or a precious metal, such as gold or platinum, or can be made of a material enabling limitation of wear by friction, such as a sintered ceramic, advantageously based on zirconia.

Additionally, in order to reduce wear of the rubbing surfaces during articulation the pivoting axis 2 is immobilized in rotation relative to the fixing element 1 and relative to the middle 20. To this end a means 3 for immobilizing the pivoting axis 2 is used, without which the pivoting axis would be free to turn about its longitudinal axis, thereby rubbing against the facing surfaces of the middle 20 and the fixing element 1. In this first embodiment the immobilizing means 3 essentially comprise a screw screwed in a longitudinal direction into a screwthread 3a in the central part of the base of the fixing element 1. Such a screw is arranged so as protrude perpendicularly into the through-orifice 1a of the fixing element 1 until it comes into contact with the pivoting axis 2 in the first, fixing configuration. This configuration is specifically depicted in FIG. 3. In the fixing configuration the body 2b of the pivoting axis 2 is therefore clamped by the screw so as to be immobilized in rotation and in translation in the through-opening 1a. Consequently the body 2b of the pivoting axis 2 no longer has any degree of freedom relative to the fixing element 1 or indirectly relative to the lugs 21 of the middle 20. The screwthread 3a is preferably machined in such a way as to conceal the screw forming the immobilizing means 3 when the wristband 30 is assembled onto the middle 20. The screw of the immobilizing means 3 is preferably a grub screw in order to be able to be buried completely in the screwthread 3a. In this first embodiment, the screw of the immobilizing means 3 is therefore hidden or concealed between the two lugs 21 when the wristband 30 is assembled onto the middle 20. In this way the screw advantageously cannot be unscrewed unintentionally and/or accidentally. Furthermore, hiding or concealing the screw of the immobilizing means 3 makes it possible to avoid compromising the overall esthetic appearance of the assembly. In a complementary manner the movement of the screw of the immobilizing means 3 in the clamping direction can optionally be limited by an axial abutment machined in the screwthread 3a and/or the screw 3. By controlling the axial position of the screw this axial abutment makes it possible to define the optimal clamping of the pivoting axis and notably to prevent too forceful clamping of the pivoting axis 2.

Finally, in this first embodiment only the connecting portions 31 retain a degree of freedom of movement in rotation relative to the pivoting axis 2, thereby enabling articulation of the wristband 30 about this pivoting axis 2 and therefore relative to the middle 20 and the fixing element 1.

Additionally, in this first embodiment an insert 4 is optionally arranged at each interface of the pivoting axis 2 with a connecting portion 31 in order to reduce wear at the level of each of these interfaces. The rubbing therefore occurs at the level of the contact between the pivoting axis and one or more inserts 4. An insert 4 advantageously and preferably takes the form of a tube or a bearing, either fixed in or simply positioned in the transverse opening 31a of a connecting portion 31.

In an embodiment in which the insert 4 is not fixed to the connecting portion 31 the transverse opening 31a can comprise a bearing surface 31d the function of which is to limit axial movement of the insert 4 and to control its position in the connecting portion 31. Alternatively, an insert 4 can be fixed or not to the body 2b of the pivoting axis 2. The body 2b of the pivoting axis 2 advantageously extends in such a manner as to cooperate with such an insert 4 at the level of a transverse opening 31a of a connecting portion 31.

Note that, because of this arrangement, in a second, assembly configuration the pivoting axis 2 makes it possible to form a locked-together assembly comprising the fixing element 1 and the connecting portions 31 of the wristband 30 and the optional inserts 4. Immobilizing the pivoting axis 2 in translation in fact makes it possible to prevent these elements from separating.

Finally, the connecting portions 31 are therefore articulated relative to the middle 20 and the fixing element 1 by cooperation of the body 2b of the pivoting axis 2 with the inserts 4. The wear of this articulation therefore depends on the inserts 4. In order to minimize this wear, these inserts are advantageously made of a suitable material. For example, the inserts 4 can be made of a sintered technical ceramic based on zirconia. Alternatively, an insert can be made of a composite material, formed for example of a mixture of a ceramic and metal, or a polymer (a thermoplastic polymer for example). An insert can be formed entirely or partly of such a material. For example, such a material can form a simple coating. An insert 4 advantageously has a hardness greater than or equal to 800 HV. Note that this use of inserts advantageously makes it possible to make the middle, including its lugs, and the fixing element 1, and even the connecting portions 31, of metal, in particular of a precious metal, such as gold or platinum, to be able to obtain the required esthetic appearance. The connecting portions 31 can notably be made of the same material as the links of the wristband. Likewise, the pivoting axis 2 can be made of steel or a precious metal. Such inserts 4 therefore make it possible to reduce the wear of the components such as the middle 20, the wristband 30 and the pivoting axis 2 made of materials such as steel, a composite material or a precious metal, such as gold or platinum. Other materials can naturally be envisaged, such as composite materials.

Note that the connecting portions 31 preferably comprise a notch 31c on their posterior face, hidden from a wearer of the wristband, this notch 31c opening onto their transverse opening 31a so that the pivots 2a are accessible by a user or a watchmaker. Using a conventional watchmaking tool such as tweezers, a pin or a pin fork, the pivots 2a can therefore be manually positioned retracted from the external flank 31b of the connecting portion 31, acting against the elastic element 2c, so as to enable the wristband 30 to be demounted from the middle 20.

Alternatively, such a notch could be made in a lug 21 of the middle 20 or in the fixing element 1, likewise to enable actuation of the end portion forming a pivot of the pivoting axis.

More generally, the solution according to the invention is advantageously such that mounting and demounting the wristband 30 can be done in the conventional way. The pivots 2a can notably comprise a notch or a groove sized so as to receive a watchmaking tool and to facilitate retracting the pivots 2a. When the wristband 30 is demounted from the middle 20 the pivoting axis 2 can preferably be demounted from the fixing element 1 by loosening the screw of the immobilizing means 3. However, this solution is advantageous in that it enables the wristband 30 and the fixing element 1 to remain assembled by means of the pivoting axis 2 in the second, assembly configuration. Such a solution therefore facilitates manipulation and assembly of this combination. The connecting portion 31 and the fixing element 1 connected together by the pivoting axis 2 therefore in fact form a fixing device locked onto the end of the wristband portion 30 that can easily take its place between the two lugs 21 of the middle 20. This advantage is present in the other embodiments.

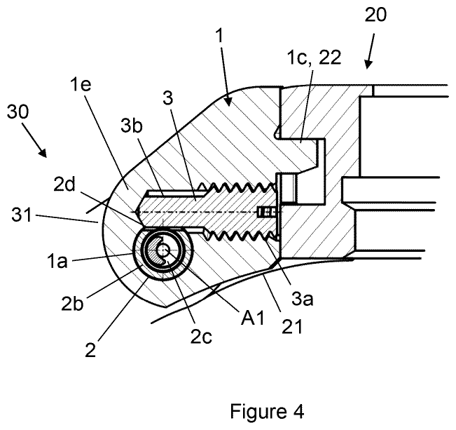

FIG. 4 represents an assembly in accordance with a second embodiment that is distinguished from the first embodiment only by the immobilizing means 3, the other components remaining substantially identical. In this second embodiment rotation of the body 2b of the pivoting axis 2 is prevented by a keying type arrangement. To this end, the screwthread 3a is disposed in a direction substantially orthoradial to the axis A1 so that its peripheral wall is substantially tangential to the peripheral wall of the transverse opening 1a. The body 2b of the pivoting axis comprises a groove 2d that extends in a direction orthoradial to the axis A1 and is intended to be aligned with the screwthread 3a. A screw of the immobilizing means 3 is therefore housed in the groove 2d of the pivoting axis 2. To be more precise, the screw comprises an end portion 3b which is preferably cylindrical, designed to be housed against the groove 2b. This arrangement enables the screw to block with less play rotation and movement in translation of the body 2b of the pivoting axis 2 relative to the fixing element 1. In this way the body 2b of the pivoting axis 2 no longer has any degree of freedom relative to the fixing element 1. In this embodiment the bottom of the screwthread 3a advantageously has the abutment function, with the result that the screw of the immobilizing means 3 abuts axially against the bottom of the screwthread 3a at the end of tightening in order to control its axial position and to clamp it in the screwthread 3a without excessively stressing the pivoting axis 2.

The invention has been depicted for a middle 20 comprising two lugs 21. However, the invention is not limited to such a geometry of the middle 20. For example, FIG. represents a third embodiment in which the middle comprises a single lug 21 with two blind transverse openings 21a or two transverse through-openings (notably adapted to form a single transverse through-opening) arranged at the level of its two opposite faces, oriented along a transverse axis A1. To fit this middle, the fixing element 1 comprises two projecting parts 1e symmetrically arranged around the lug 21 at a distance from the lug 21 substantially equal to the width of a link of the wristband. These projecting parts 1e include blind transverse openings 1a at the level of their internal surface, again oriented along the axis A1. In this embodiment, the geometries of the lug 21 and the projecting parts 1e are therefore reversed relative to the previous embodiments. Note that the two projecting parts 1e can be arranged on a single fixing element 1 or on respective distinct fixing elements 1. The wristband portion 30 can be identical to that of the first two embodiments. The two connecting portions 31 of the wristband portion 30 are housed around the lug 21, between the lug 21 and a respective projecting part 1e. In this third embodiment two pivoting axis 2 are arranged along the axis A1 to fix each respective connecting portion 31 in the lug 21 and on a projecting portion 1e. Each pivoting axis 2 comprises at least one pivot 2a positioned in a transverse opening 21a of the lug 21 and a body 2b disposed in a projecting part 1e, and at least in part through a transverse opening 31a of a connecting portion 31. On the other hand, each pivoting axis 2 is immobilized in rotation by an immobilizing means 3 arranged at the level of a projecting part 1e.

This third embodiment therefore comprises two immobilizing means 3 each cooperating with a respective pivoting axis 2. Each immobilizing means 3 can embody one of the solutions of the foregoing two embodiments. At least one insert 4 is moreover arranged in each connecting portion 31, functioning as described in connection with the first embodiment. Note that in this embodiment the lug 21 of the middle 20 is positioned in the space between the two connecting portions 31 of the at least one wristband portion 30 and is no longer a projecting part 1e of the fixing element 1 as in the preceding embodiments.

In a variant embodiment the transverse position of the projecting parts 1e and the transverse position of the connecting portions 31 can be interchanged.

The invention is naturally not limited to the precise geometry of the various elements represented.

As mentioned above, in one embodiment the connecting portions are at the ends of a wristband. Two connecting portions have been described by way of example. The wristband could instead comprise more than two connecting portions, notably three connecting portions, and more generally at least two connecting portions.

On the other hand, when the wristband comprises an assembly of links, notably metal links, a connecting portion advantageously takes the form of a connecting link arranged at the end of the wristband, advantageously projecting from it, which has a shape identical or similar to other links of the wristband to impart a continuous esthetic appearance. The invention has been depicted with reference to a wristband comprising five rows of links. It could naturally be applied to a wristband comprising a different number of rows of links, for example three rows of links. The connecting portions are advantageously links of the wristband. However, they could instead be distinct from the links of the wristband and have a geometry other than that of these links. If the wristband comprises rigid links connected to one another in an articulated manner it can therefore comprise at least three or five rows of links extending longitudinally, these rows of links being juxtaposed and offset to one another so that two directly juxtaposed links belonging to two rows of distinct directly juxtaposed links are offset relative to one another in the longitudinal direction. The connecting portions are advantageously formed by at least two end links forming connecting links and being part of two respective rows of intermediate links separated by at least one row of links so that said two end links are separated from one another by a space corresponding to the width of at least one link.

In a variant embodiment the wristband can be made of a flexible material, for example leather or a polymer (elastomer, thermoplastic polymer, thermoplastic-elastomer). In this case, the connecting parts can be arranged at the ends of the flexible wristband and could be made of a material such as steel, a composite material or a precious metal, such as gold or platinum, or a material enabling limitation of wear by rubbing, such as a sintered ceramic, advantageously based on zirconia. Alternatively, the connecting portions 31 could be part of a wristband portion 30 made of a flexible material, these connecting portions 31 also being made of a flexible material. At least one insert 4 should advantageously be arranged inside it.

Furthermore, the invention has been depicted with traditional middles with one or two lugs. Such lugs could naturally have any other, not necessarily standardized, geometry. Likewise, the middle could have any other geometry forming part of a watch casing.

The middle is advantageously arranged in line with the wristband and has a total width substantially equal to the width of the wristband measured in the transverse direction. The measured distance from an exterior or interior end, preferably an exterior end, of a first lug to the exterior or interior end, preferably the exterior end, of a second lug substantially corresponds to the width of the wristband in the case of a middle with two lugs as described in connection with the first two embodiments. Alternatively, in the case of a middle with only one lug as described in the third embodiment the measured distance from an exterior or interior end, preferably an interior end, of a projecting first part to the exterior or interior end, preferably the interior end, of a second projecting part, these projecting parts being part of one or two fixing elements, substantially corresponds to the width of the wristband.

As mentioned above, the arrangement can comprise one or two or even more pivoting axis. Thus it comprises at least one pivoting axis. Each pivoting axis can have any geometry other than that represented. For example, the pivoting axis can be non-cylindrical in whole or in part and for example has a cross section that is square, three-lobed or half-moon shaped, notably so as to immobilize its rotation in its respective housing. The pivoting axis can also comprise at least one bearing surface to form an axial abutment enabling precise positioning in its housing. Its pivot or pivots is or are advantageously integrated into at least one lug of the middle.

An immobilizing means is used to prevent rotation of the pivoting axis relative to certain components, as described, in order to limit wear. In fact, it is advantageously sufficient to maintain possible rotation of the wristband relative to the watch casing either by rotation of the wristband around the pivoting axis or by rotation of the watch casing relative to the pivoting axis. In the embodiments described the immobilizing means act on the pivoting axis at the level of the fixing element. It could therefore instead act at the level of a lug or at the level of a connecting portion of the wristband: in this latter case, the pivoting axis 2 would therefore be fixed in the connection portions 31 and free to rotate at the level of the fixing element and at least one lug. To form robust and controlled rubbing surfaces one or more inserts is or are optionally arranged at the level of the pivoting axis when it is free to rotate.

On the other hand, the immobilizing means can be implemented by a solution other than those described. For example, it can comprise a non-circular pivoting axis section cooperating with a corresponding section of the transverse openings 31a of the respective at least two connecting portions 31 or the transverse opening of the at least one projecting part of the fixing element and/or the transverse opening of the at least one lug, so as to prevent rotation of the pivoting axis relative to the fixing element and/or to the at least one lug. Alternatively or additionally the immobilizing means can comprise a mounted element, notably a key or a screw as described hereinabove, protruding into a transverse opening so as to come into contact with the pivoting axis to prevent its rotation and possibly its movement in translation through friction and/or by forming an obstacle.

The fixing element makes it possible to complete the middle and/or the wristband to form a distinct and complementary element facilitating fixing the wristband onto the watch casing. The fixing element could therefore have any shape enabling reception of a pivoting axis. It can be associated with a watch casing through a plurality of approaches. For example, this association can be simple nesting with no fixing by means of a shape making it possible to limit or to eliminate the degrees of freedom, the articulation pin or pins then guaranteeing its retention. The fixing element can instead be fixed to the watch casing by a fixing means such as a screw or a clip or by driving, gluing or welding.

An optional insert has been envisaged to minimize wear by rubbing. Such an insert could be wholly or partially non-cylindrical and have for example a cross section that is square, three-lobed or half-moon shaped, so as notably to prevent it rotating in its respective housing or relative to the pin. An insert could also comprise at least one bearing surface to form an axial abutment enabling precise positioning in its housing.

1. A timepiece comprising:
a middle,
at least one wristband portion extending in a longitudinal direction and removably fixed to the middle, and capable of occupying a first, fixing configuration in which the at least one wristband portion is fixed to the middle and a second, assembly configuration in which the at least one wristband portion is detached from the middle,
wherein:
the middle comprises at least one lug comprising a transverse opening,
the timepiece comprises at least one fixing element distinct from the middle and from the at least one wristband portion, the at least one fixing element comprising a transverse opening (la),
an end of the at least one wristband portion comprises at least two connecting portions projecting in a longitudinal direction at the end of the at least one wristband portion and being transversely separated from one another by a gap, the at least two connecting portions each comprising transverse openings,
in a first, fixing configuration, at least one pivoting axis is housed in the transverse opening of the at least one lug, in the transverse opening of the at least one fixing element, and in the transverse openings of the respective at least two connecting portions of the wristband, so as to retain fixed between the at least two connecting portions the middle, the at least one wristband portion and the at least one fixing element,
in a first, fixing configuration, an immobilizing means immobilizes the at least one pivoting axis against rotation relative to the at least one lug and relative to the at least one fixing element, or relative to the connecting portions, so that only the respective at least two connecting portions of the at least one wristband portion or the at least one lug and the at least one fixing element (Hare mobile in rotation about the at least one pivoting axis.

2. The timepiece as claimed in claim 1, wherein in the first, fixing configuration a lug of the middle or a projecting part of the at least one fixing element comprising the transverse opening is positioned in the gap between the two connecting portions of the at least one wristband portion.

3. The timepiece as claimed in claim 1, wherein an insert is arranged in the transverse openings of each respective connection portion of the at least one wristband portion or in the transverse opening of at least one fixing element and/or in the transverse opening of the at least one lug to form a first, fixing configuration interface and limit wear by rubbing.

4. The timepiece as claimed in claim 3, wherein
the insert is made entirely of a sintered technical ceramic or of a composite material formed of a mixture of a technical ceramic and a metal or a polymer, and/or
the insert comprises a sintered technical ceramic coating or a composite material formed of a mixture of a technical ceramic and a metal or a polymer, and/or
the insert has a hardness greater than or equal to 800 HV.

5. The timepiece as claimed in claim 1, wherein:
the at least one wristband portion comprises rigid links connected together in an articulated manner and comprises at least three or five rows of links extending longitudinally, the rows of links being juxtaposed and offset from one another so that two directly juxtaposed links belonging to two distinct and directly juxtaposed rows of links are offset relative to one another in the longitudinal direction, the at least two connecting portions comprising two end links belonging to respective rows of links separated by at least one row of links so that the two end links are separated from one another by the gap corresponding to the width of at least one link; or
the at least one wristband portion is flexible and comprises the at least two connecting portions projecting at an end of the at least one wristband portion.

6. The timepiece as claimed in claim 1, wherein in a first, fixing configuration the immobilizing means immobilize the at least one pivoting axis against movement in translation in the transverse direction.

7. The timepiece as claimed in claim 1, wherein in a second, assembly configuration the immobilizing means immobilize the at least one pivoting axis against movement in translation in the transverse direction so as to retain the at least one fixing element assembled to the at least two connecting portions.

8. The timepiece as claimed in claim 1, wherein the immobilizing means consists in:
a non-circular section of the at least one pivoting axis cooperating with a corresponding section of the transverse openings of the respective at least two connecting portions or of the transverse opening of the at least one projecting part of the at least one fixing element and/or the transverse opening of the at least one lug so as to immobilize the at least one pivoting axis against rotation relative to the at least two connecting portions or to the at least one fixing element and/or to the at least one lug, or
a mounted element protruding into the transverse opening of the respective at least two connecting portions or the transverse opening of the at least one projecting part of the at least one fixing element and/or the transverse opening of the at least one lug so as to come into contact with the at least one pivoting axis to immobilize the at least one pivoting axis against rotation and possibly against movement in translation by friction and/or by forming an obstacle.

9. The timepiece as claimed in claim 1, wherein, to prevent untimely release thereof, in the first, fixing configuration the immobilizing means is adapted to be hidden or concealed and inaccessible.

10. The timepiece as claimed in claim 1, wherein the immobilizing means is a screw screwed into a screwthread in the transverse opening of the respective at least two connecting portions or of the transverse opening of the at least one fixing element and/or of the transverse opening of the at least one lug and the immobilizing means and/or the screwthread comprise(s) an abutment enabling optimal clamping of the pivoting axis in the first, fixing configuration.

11. The timepiece as claimed in claim 1, wherein in the first, fixing configuration the at least one fixing element is positioned in a housing of the middle to provide a connection with no degree of freedom between the at least one fixing element and the middle or in the first, fixing configuration the at least one fixing element is fixed to the middle by fixing means such as screwing, driving, gluing or clipping.

12. The timepiece as claimed in claim 11, wherein the fixing element comprises a base having a volume defined to take its place with a snug fit between the two lugs of the middle in the case of a middle with two lugs and/or the fixing element comprises a base comprising a surface intended to come to bear against the surface of the middle, thereby espousing the curvature of that surface of the middle, and/or the fixing element comprises a base comprising a projecting connecting portion, respectively a hollow portion, intended to cooperate with a complementary hollow portion, respectively a complementary projection of the middle.

13. The timepiece as claimed in claim 11, wherein the at least one pivoting axis comprises at least one end portion forming a pivot continues to project because of the effect of an elastic element, the at least one end portion forming a pivot housed in a transverse opening of the at least one lug in the first, fixing configuration.

14. The timepiece as claimed in claim 13, wherein the timepiece comprises a notch in a connecting portion, a lug of the middle or in the at least one fixing element to enable actuation of the at least one end portion forming a pivot projecting from the at least one pivoting axis and moving the at least one pivoting axis to the position projecting toward a retracted position against the force exerted by the elastic element to go from the first, fixing configuration to the second, assembly configuration and vice versa.

15. The timepiece as claimed in claim 1, wherein the middle comprises two lugs each comprising a blind transverse opening, the at least one fixing element comprises only one projecting part disposed between the two lugs and extending substantially parallel to the two lugs in a first, fixing configuration, and the at least one wristband portion comprises two connecting portions disposed between a respective lug and the projecting part He) of the at least one fixing element in the first, fixing configuration so as to align the blind transverse openings of the two lugs, the transverse opening through the at least one fixing element and the two transverse through-openings of each respective one of the two connecting portions, all these openings receiving the at least one pivoting axis in the first, fixing configuration.

16. The timepiece as claimed in claim 1, wherein the middle comprises a single lug comprising at least one transverse through-opening, the fixing element or elements comprise two projecting parts disposed on respective opposite sides of the lug and extending substantially parallel to the lug in the first, fixing configuration and the at least one wristband portion comprises two connecting portions respectively disposed between the lug and a projecting part in the first, fixing configuration so as to align the at least one transverse opening of the lug, the blind transverse opening of each respective one of the two projecting parts and the two transverse openings of each of the respective two connecting portions, all the openings receiving the at least one pivoting axis in the first, fixing configuration.

17. The timepiece as claimed in claim 1, wherein a total width of the at least one wristband measured in the transverse direction is equal to the distance from an exterior or interior end of a first lug to an exterior or interior end of a second lug in a case of a middle with two lugs or is equal to a distance measured from an interior or exterior end of a first projecting part to the interior or exterior end of a second projecting part of the at least one fixing element in a case of a middle with only one lug.

18. The timepiece as claimed in claim 1, wherein the at least two connecting portions are at least two connecting links.

19. The timepiece as claimed in claim 8, wherein the mounted element is a grub screw.

20. The timepiece as claimed in claim 12, wherein the projecting connecting portion has a shape of a rib.
